(19) United States
(12) Patent Application Publication
(10) Pub. No.: US 2009/0022947 A1
(43) Pub. Date: Jan. 22, 2009

(54) Wear-proof structure for a flexible circuit in an optical disk drive

(75) Inventors: Hsien-Chung Ou, Taoyuan (TW); Li-Li Yang, Taoyuan (TW); Chen-Fu Chang, Taoyuan (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan (TW)

(21) Appl. No.: 12/081,815

(22) Filed: Apr. 22, 2008

(30) Foreign Application Priority Data
Jul. 19, 2007 (TW) 96126489

(51) Int. Cl. B32B 3/02

(52) U.S. Cl. 428/121

(57) ABSTRACT

A wear-proof structure for a flexible circuit disposed within a casing of an optical disk drive is provided. The casing has an entrance. A tray is disposed within the casing and its underside is covered by a protection plate. The protection plate has one end bent upwardly to form a tail with an arc-shaped cross-section. The flexible circuit includes a fixed portion and a movable portion. The fixed portion is immovably disposed on the casing. The movable portion is connected to one end of the fixed portion and extended toward the other end of the fixed portion to form a folded end with the fixed portion, and the folded end is immovably disposed near the entrance. A wear-proof layer is covered on the folded end; besides, the wear-proof layer has a wing outstretched the folded end and pasted on the casing to enhance the wear-proof ability of the flexible circuit.

This application claims the benefit of Taiwan application Serial No. 96126489, filed Jul. 19, 2007, the subject matter of which is incorporated herein by reference.

### BACKGROUND OF THE INVENTION

1. Field of the Invention

The invention relates in general to a wear-proof structure, and more particularly to a wear-proof structure for a flexible circuit electrically connected to a tray and a main board in a slim type optical disk drive.

2. Description of the Related Art

A conventional slim type optical disk drive employs a flexible circuit to electrically connect a movable tray to a fixed main board so as to provide power for the electric components on the tray as well as to control the signal transmission of data when reading and writing. As the tray moves in or out of the optical disk drive, it usually presses and rubs against the flexible circuit. Once the surface of the flexible circuit suffers wear and tear, the signal transmission is affected, reducing the reliability of the optical disk drive.

FIG. 1 is a diagram showing a conventional slim type optical disk drive 1. The optical disk drive 1 has an empty casing 2 used for receiving a main board 3 and a tray 4. A flexible circuit 5 is connected to the main board 3 and the tray 4. The flexible circuit 5 is, for example, flexible printed circuit (FPC) or flexible flat circuit (FFC). FPC is thinner in thickness but more expensive than FFC, and it is not arranged in an overlapped manner. However, FFC is disposed in an overlapped manner, easily manufactured and cheaper, having been gradually taking the place of FPC. The flexible circuit 5 is folded up when disposed within the disk drive 1. The flexible circuit 5 has a fixed portion 6 and a movable portion 7. The fixed portion 6 beneath the tray 4 is attached to an underside inside the casing 2, and the fixed portion 6 has one end connected to the main board 3 and the other end connected to the movable portion 7. The movable portion 7 above the fixed portion 6 has one end connected to a circuit board 8 under the tray 4 to supply power to a spindle motor 9 and an optical pick-up unit (OPU) 10 on the tray 4 as well as to control the signal transmission of data. A metallic protection plate 11 is covered on the underside of the tray 4 and is movable with the tray 4 to protect the circuit board 8 from electromagnetic interference (EMI). The tray 4 is able to move in or out of the casing 2, so as to let an optical disk 12 be played or replaced. As the spindle motor 9 rotates the optical disk 12, the OPU 10 is controlled to move back and forth along the radial direction of the disk 12 to read data from the disk 12. The data read by the OPU 10 is then transmitted through the circuit board 8 and the flexible circuit 5 to the main board 3 to be processed.

For the convenience of being carried around, the thickness of the slim type optical disk drive 1 used in a laptop computer is limited. As such, the protection plate 11 under the tray 4 is very close to the movable portion 7 of the flexible circuit 5 when sliding above the movable portion 7. Additionally, guide bars used for supporting the tray 4 to slide have larger tolerance of assembly in order to facilitate the sliding of the tray 4. Consequentially, when the tray 4 moving into the disk drive 1 endures press or vibration, the rear end of the protection plate 11 is forced to lean against or even scrape the surface on the movable portion 7 of the flexible circuit 5. And soon the conducting lines inside the flexible circuit 5 would become ruined, being unable to transmit signal properly. For preventing the rear end of the protection plate 11 from contacting with the surface on the movable portion 7 of the flexible circuit 5, a fillister 13 is formed on the casing 2 at the front end of the fixed portion 6 for receiving the folded end of the flexible circuit 5, so as to increase the distance between the flexible circuit 5 and the protection plate 11.

However, the fillister 13 is usually formed on the casing 2 by a punch press, increasing the manufacturing cost as well as the thickness of the disk drive 1. The size of the disk drive 1 could no longer be reduced in thickness, not satisfying the requirement for a slim type disk drive. In addition, the disposition of the protruding fillister does not maintain the surface flatness of the casing, causing difficulty to dealing with the flatness of the disk drive. Moreover, although the distance between the protection plate and the folded end of the flexible circuit is increased due to the fillister, the fillister only can be formed within a limited region considering the influence on the casing. Thus, the conventional way is not sufficient to thoroughly solve the problem of scraping the rear end of the flexible circuit.

### SUMMARY OF THE INVENTION

It is therefore an object of the invention to provide a wear-proof structure for a flexible circuit in an optical disk drive. A wear-proof layer is disposed on the flexible circuit to enhance its wear-proof ability, protecting the conducting lines inside the flexible circuit from being damaged.

It is therefore another object of the invention to provide a wear-proof structure for a flexible circuit in an optical disk drive. A wear-proof layer of an appropriate thickness is directly covered on the flexible circuit, so as to simplify the assembling procedure as well as to reduce the manufacturing time and cost.

The invention achieves the above-identified object by providing a wear-proof structure for a flexible circuit disposed within a casing of an optical disk drive. The casing has an entrance and receives a tray that has an underside covered by a protection plate. The protection plate has one end bent upwardly to form a tail with an arc-shaped cross-section. The fixed portion of the flexible circuit is immovably disposed on the casing. The movable portion of the flexible circuit is connected to one end of the fixed portion and extended toward the other end of the fixed portion to form a folded end with the fixed portion. The folded end is immovably disposed near the entrance. A wear-proof layer is covered on the folded end. Besides, the wear-proof layer has a wing that is outstretched the folded end and is pasted on the casing.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram showing a conventional slim type optical disk drive;

FIG. 2 is a diagram showing an optical disk drive that has a wear-proof structure according to a first embodiment of the invention;

FIG. 3 is a diagram showing the flexible circuit of the first embodiment;

FIG. 4 is a diagram showing the working situation of the wear-proof layer on the flexible circuit of the first embodiment;

FIG. 5 is a diagram showing the tray in FIG. 4 moving into the casing; and

FIG. 6 is a diagram showing a wear-proof structure according to a second embodiment of the invention.

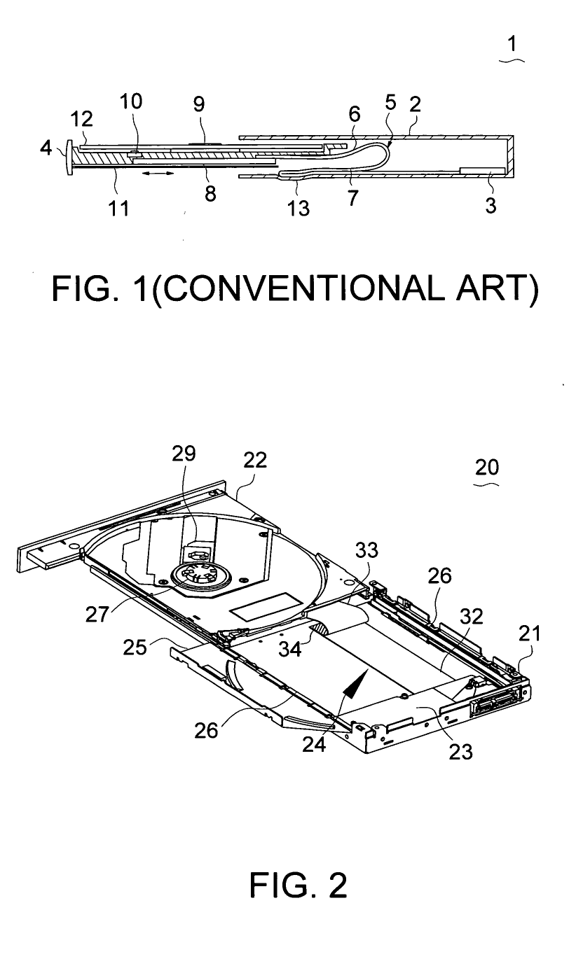

### DETAILED DESCRIPTION OF THE INVENTION

FIG. 2 is a diagram showing an optical disk drive 20 that has a wear-proof structure according to a first embodiment of the invention. The optical disk drive 20 includes a casing 21, a tray 22, a main board 23 and a flexible circuit 24. The casing 21 is hollow so that the tray 22 is able to move in or out of the casing 21. The flexible circuit 24 is connected to the rear end of tray 22 and to the main board 23 that is disposed on the rear side of the casing 21, maintaining the signal transmission and control between the tray 22 and the main board 23 whenever the tray 22 is inside or outside the casing 21.

The front side of the hollow casing 21 has an entrance 25. Each of the two sides of the casing 21 has a guide bar 26 disposed thereon. The main board 23 is disposed on the rear side of the casing 21. The tray 22 has two sides supported by the guide bars 26 to move in or out of the casing 21 through the entrance 25, so as to let a disk on the tray 22 be played or replaced. A spindle motor 27 is disposed at the center of the tray 22 for rotating the disk 28 (shown in FIG. 4). An optical pick-up unit (OPU) 29 also is disposed on the tray 22 and is movable along a radial direction of the disk 28 to read data from the disk 28. A circuit board 30 (shown in FIG. 4) under the tray 22 is used for controlling the spindle motor 27 and the OPU 29. A metallic protection plate 31 is covered on the underside of the circuit board 30 and is movable along with the tray 22 to protect the delicate electronic components on the circuit board 30 from electromagnetic interference (EMI). Additionally, one end of the protection plate 31 is bent upward to form a tail 36 with an arc-shaped cross-section for avoiding damaging the circuit board 30.

The flexible circuit 24 in the embodiment is a flexible and long sheet-shaped circuit. The flexible circuit 24 is, for example, a flexible flat circuit (FFC) that includes a fixed portion 32 and a movable portion 33. The fixed portion 32 has one end connected to the main board 23, and the rest of the fixed portion 32 is attached to the underside of the casing 21 in the direction toward the entrance 25. The fixed portion 32 can be pasted or riveted to the casing 21, and the length of the fixed portion 32 on the casing 21 is determined according to the moving distance of the tray 22.

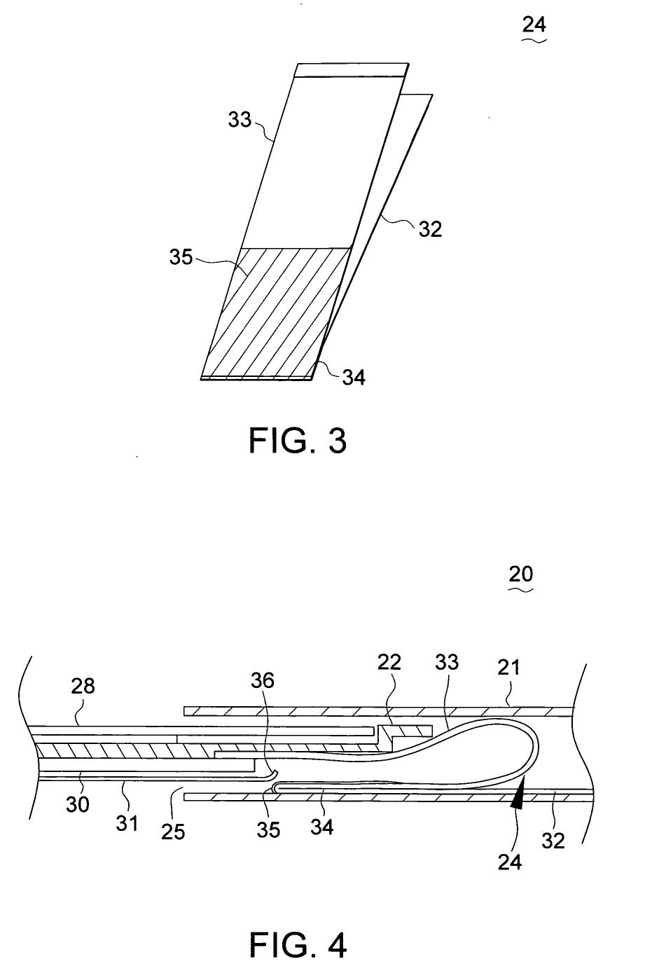

The movable portion 33 is connected to the fixed portion 32 near the entrance 25. As shown in FIG. 3, the movable portion 33 folded from the flexible circuit 24 is extended toward the inside of the casing 21 and forms a folded end 34 with the fixed portion 32. Part of the movable portion 33 overlapping the fixed portion 32 is attached thereon, and the rest of the movable portion 33 is movably disposed above the fixed portion 32. A wear-proof layer 35, which is marked by hatches in FIG. 3, is covered on the surface of the movable portion 33, especially covered on the surface of the folded end 34 and its nearby area that is easily rubbed. The wear-proof layer 35 is pasted or coated on the movable portion 33, and its material is, for example, a wear-proof gel. The movable portion 33 has one end connected to the rear side of the tray 22 and electrically connected to the circuit board 30; accordingly, the main board 23 is electrically connected to the circuit board 30 through the flexible circuit 24.

FIG. 4 is a diagram showing the working situation of the wear-proof layer 35 on the flexible circuit 24 of the first embodiment. The fixed portion 32 of the flexible circuit 24 is nestled up against the casing 21 and the folded end 34 is adjacent to the entrance 25. The tray 22 outside the disk drive 20 draws the movable portion 33 adjoining the tray 22 to fold and to extend toward the entrance 25. When the tray 22 moving into the casing 21 is pressed or vibrated, the tail 36 of the protection plate 31 underneath would possibly hit the folded end 34 of the flexible circuit 24. Due to the wear-proof layer 35 covered on the folded end 34 and on part of the movable portion 33, the tail 36 first contacts with the wear-proof layer 35, then the tail 36 in large arc shape slides into the casing 21 along the wear-proof layer 35, rubbing against without scraping the wear-proof layer 35. The flexible circuit 24 therefore is protected from being damaged with the help of wear-proof layer 35.

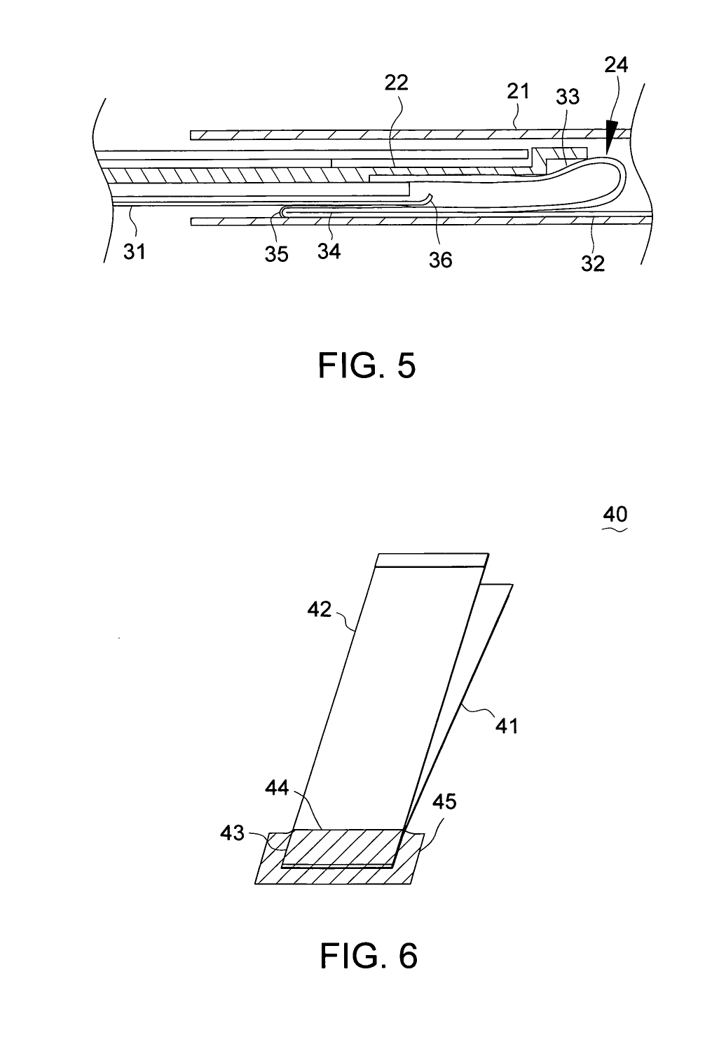

FIG. 5 is a diagram showing the tray 22 in FIG. 4 moving into the casing 21. As the tail 36 of the protection plate 31 slides along the wear-proof layer 35, the tray 22 gradually lays the movable portion 33 flat on the fixed portion 32. Additionally, the protection plate 31 is slightly lifted up by the wear-proof layer 35, avoiding rubbing against the movable portion 33 at the rear end of the flexible circuit 24 that is lower than the wear-proof layer 35. The wear-proof layer 35 provides the flexible circuit 24 with thorough protection.

FIG. 6 is a diagram showing a wear-proof structure according to a second embodiment of the invention. The fixed portion 41, movable portion 42 and folded end 43 of the flexible circuit 40 in the embodiment are similar to those of the flexible circuit 20 of the first embodiment in the aspects of connecting manner and essential structure. However, the flexible circuit 40 has a wear-proof layer 44 that is different from the wear-proof layer 35 of the first embodiment. The wear-proof layer 44 is covered on the folded end 43 and has a wing 45 outstretched the folded end 43 and pasted on the casing. The wing 45 of a proper width is sufficient to enhance the adhesion of the folded end 43 on the casing. The wear-proof layer 44 not only protects the folded end 43, which is usually hit by the protection plate, from being worn out, but also prevents the folded end 43 coming off the casing, so as to avoid affecting the moving of the tray relative to the casing.

The wear-proof structure for the flexible circuit in a slim type optical disk drive according to the embodiment of the invention includes a wear-proof layer covered on the flexible circuit to enhance the wear-proof ability thereof. One end of the protection plate in the disk drive is bent upward to form a tail with an arc-shaped cross-section for facilitating the motion of sliding and for avoiding damaging the conducting lines inside the flexible circuit. Moreover, the wear-proof layer of an appropriate thickness can be directly formed on the movable portion of the flexible circuit in the process of manufacturing the flexible circuit, so that the time for manufacturing and assembling the wear-proof layer is saved accordingly. Additionally, the surface of the casing needs no change and the wear-proof layer is formed as a thin film structure, thus the thickness of the slim type optical disk drive is not increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wear-proof structure for a flexible circuit of an optical disk drive that has a casing with an entrance, comprising:
a fixed portion immovably disposed on the casing;
a movable portion connected to one end of the fixed portion and extended toward the other end of the fixed portion, forming a folded end with the fixed portion, wherein the folded end is immovably disposed near the entrance; and
a wear-proof layer covered on the folded end.

2. The wear-proof structure according to claim 1, wherein the folded end and part of the movable portion overlapping the fixed portion are attached on the fixed portion to form a flexible flat circuit.

3. The wear-proof structure according to claim 2, wherein the wear-proof layer is covered on the folded end and on the surface of the movable portion adjacent to the folded end.

4. The wear-proof structure according to claim 3, wherein the wear-proof layer is covered on the surface of the movable portion.

5. The wear-proof structure according to claim 1, wherein the wear-proof layer is formed from a material with a wear-proof property, and the wear-proof layer is pasted or coated on the flexible circuit.

6. The wear-proof structure according to claim 1, wherein the disk drive comprises a tray disposed within the casing, the underside of the tray is covered by a protection plate, and the rear end of the protection plate is bent upward to form a tail with an arc-shaped cross-section.

7. The wear-proof structure according to claim 6, wherein the tail has a large arc-shaped cross-section.

8. The wear-proof structure according to claim 1, wherein the wear-proof layer is covered on the folded end and has a wing outstretched the folded end.

9. The wear-proof structure according to claim 8, wherein the wing is outstretched three sides of folded end.

10. The wear-proof structure according to claim 8, wherein the outstretched wing of the wear-proof layer is pasted on the casting.
